(19) United States
(12) Patent Application Publication
(10) Pub. No.: US 2013/0117152 A1
(43) Pub. Date: May 9, 2013

(54) Javascript Widget Storefront

(71) Applicants: Waheed Youssef Mebed, Fountain Valley, CA (US); Joshua Wade Glasser, Santa Ana, CA (US)

(72) Inventors: Waheed Youssef Mebed, Fountain Valley, CA (US); Joshua Wade Glasser, Santa Ana, CA (US)

(73) Assignee: CBS INTERACTIVE, INC., San Francisco, CA (US)

(21) Appl. No.: 13/288,802

(22) Filed: Nov. 3, 2011

(51) Int. Cl. G06Q 30/00

(52) U.S. Cl. 705/26.9; 705/27.2; 705/27.1

(57) ABSTRACT

The disclosed technology provides an electronic storefront to present product information in real-time. In some embodiments, a website can comprise a widget that provides an electronic storefront in real-time to present data relating to product information. For example, a website developer can be provided with a snippet of computer code for generating a JavaScript hook or widget, thereby obviating the need for the developer to produce his own customized computer code for the storefront, which can cost time and money.

### FIELD OF TECHNOLOGY

The present disclosure relates to providing code for an online storefront. More particularly, the present disclosure relates to providing an electronic storefront on a website via a widget including granting access to product information.

### BACKGROUND

Consumers of consumer electronics (CE), such as personal computers, digital media players, cellular phones, hard disk drives, etc., want detailed information of product features and specifications to make informed purchasing decisions. Manufacturers typically provide information on their products, but this information may not be normalized between different manufacturers. For example, some manufacturers may use proprietary names for the same features in an attempt to differentiate themselves from the competition. For example, a manufacturer can call a display “qHD” instead of 960×540 pixels. This can confuse consumers because they do not understand the difference, if any, between the different ways that websites describe similar features. Therefore, manufacturers can normalize product information to present users with information in a consistent manner to aid in purchasing decisions.

It can be very burdensome for each retailer to create its own database of product information. Retailers can at any time be offering hundreds or thousands of products, thereby making it impossible, or very expensive to create a database of all product information. Moreover, there is a very high turnover in CE products. Products are constantly being updated and replaced. Thus, product information databases must be constantly updated.

Furthermore, it can also be very burdensome for each retailer to create its own storefront (e.g., electronic storefront on its website). A retailer will need to spend extra time and money to develop computer code to generate its own electronic storefront. The product information provided by the storefront must also be maintained, leading to more burdens for a retailer. The present technology described herein addresses some of these concerns.

### SUMMARY

Additional features and advantages of the concepts disclosed herein are set forth in the description which follows, and in part will be obvious from the description, or may be learned by practice of the described technologies. The features and advantages of the concepts may be realized and obtained by means of the instruments and combinations particularly pointed out in the appended claims. These and other features of the described technologies will become more fully apparent from the following description and appended claims, or may be learned by the practice of the disclosed concepts as set forth herein.

The present disclosure describes providing an electronic storefront to present product information in real-time. In some embodiments, a website can include a widget that provides an electronic storefront in real-time to present data relating to product information. For example, a website developer can be provided with a snippet of computer code for generating a JavaScript hook or widget, thereby obviating the need for the developer to produce his own customized computer code for the storefront, which can cost time and money. In some embodiments, the storefront widget is displayed in real-time to a visitor of a webpage when the visitor hovers or rolls his mouse over text containing a product name of a certain product, such as a consumer electronic. The widget can retrieve from an external product reference resource, such as a server and/or database, product data relating to product information for the certain product. The retrieved data relating to product information can be displayed to the visitor in real-time via the storefront widget.

In some embodiments, products can be consumer electronics, such as TVs, DVD players, smartphones, etc. In some embodiments, data relating to product information can include brand name, manufacturer, product name, model type/number, product description, price, product reviews, user/consumer reviews, and product availability and location(s) (e.g., addresses of retail stores).

In some embodiments, products can be media products such as music, movies, books, TV shows, etc. For example, a widget can be displayed on a webpage where media is mentioned. A webpage can mention a song, movie, TV show, book, etc. (e.g., a blogger on a blog site can talk about his favorite book, a person on a social networking site can mention a movie title, a web user can update his status message to reflect what song he is listening to at the moment). A widget can be displayed for each of these media products as a person browsing these sites (i.e., potential consumer) hovers his mouse over them. The widgets can provide the full product name (e.g., title), author, director, producer, editor, cast, a sample media clip, excerpt, or abstract, price, and other information about the media product. In some embodiments, widgets can provide a click button(s) for convenient shopping (e.g., “Purchase,” “Bid,” “Add to cart,” “Process”).

In some embodiments, a webpage can display a video. There can be a product(s) shown within the video. A widget can be displayed to a visitor of the webpage to provide him with information and data relating to the product(s) in the video. For example, if the video has been tagged with a keyword(s) “Brand name Camera Model XYZ,” then the widget can be made available to the visitor to display product information about the camera (e.g., when the visitor moves his mouse over the product shown in the video, or when the visitor moves his mouse over the video tag/keyword). Similarly, if the video properties state which camera was used to record the video, then the widget can also display product information about that camera to the visitor. In addition, if the video description mentions the camera, the widget can display product information about the camera.

In some embodiments, a webpage can present audio. There can be a product(s) mentioned within the audio. A widget can be displayed to a visitor of the webpage to provide him with information and data relating to the product(s) in the audio. For example, if the audio has been tagged with a keyword(s) “Brand name Microphone Model XYZ,” then the widget can be made available to the visitor to display product information about the microphone. Similarly, if the audio properties or description mentions the microphone, then the widget can also display product information about the microphone to the visitor. In addition, in some embodiments, speech-to-text software can be used to decipher the audio into text. If the audio and/or text mention the microphone, the widget can display information about it.

In some embodiments, a webpage can present an image. There can be a product(s) depicted within the image. For example, the picture can have a description or tags describing it. Any products mentioned can be provided by a storefront widget. In some embodiments, a person's face can be deciphered using facial recognition software. The person can be an author, singer, actor, etc. Media and other products associated with the person can be provided by the widget. Similarly, any other products recognized in the image can be provided by the widget as well.

In some embodiments, a webpage can present a game. In the game, there can be any number of real or virtual products. For example, in a Role Playing Game (RPG), a real or virtual item can be presented as a product via a widget. In a racing game, a car within the game can be presented as a product via a widget. Moreover, the game can utilize real or virtual currency for shopping. A widget can provide a storefront for using real and/or virtual currency.

In some embodiments, a webpage can present a restaurant or other business. A widget on the webpage can provide meal vouchers, coupons, tickets, or any other merchandise/products mentioned.

In some embodiments the external product reference resource can also aggregate request data from the widget. Such data can include product data, and in aggregate can indicate consumer interest in a product. Further, in some embodiments, the widget can also return data useful in building a profile regarding a user, including demographic data, user identification data, behavioral data, ect.

In some embodiments the external product reference resource can also aggregate purchase data based on products purchased through the interface provided by the widget.

### BRIEF DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates a prior art storefront providing product information on a generic webpage;

FIG. 2 illustrates an exemplary embodiment including a widget used on a website for accessing the product information of FIG. 1 and providing a storefront;

FIG. 3 illustrates an exemplary embodiment including a more customized widget for accessing product information and providing a storefront on a website;

FIG. 4 illustrates an exemplary embodiment including a widget for providing a storefront and displaying product information;

FIG. 5 illustrates an exemplary embodiment including a storefront widget communicating with a remote server(s);

FIG. 6 illustrates an exemplary embodiment including a widget for providing a storefront and displaying product information encompassing product availability and locations;

FIG. 7 illustrates an exemplary embodiment including a storefront widget communicating with a mapping service;

FIG. 8 illustrates an exemplary method embodiment for facilitating a widget to provide a storefront on a website to display product information in real-time;

FIG. 9 illustrates an exemplary method embodiment for providing a storefront on a website to display product information in real-time via a widget;

FIG. 10 illustrates an exemplary system embodiment for serving product information to a web server; and

FIG. 11 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other embodiments, implementations, variations, steps, and/or orders of steps may be used without departing from the spirit and scope of the disclosure.

Electronic commerce (“e-commerce”) encompasses the buying and selling of products and services (referred to herein collectively as “products”) over electronic systems such as the Internet and other computer networks. E-commerce typically uses the World Wide Web at least at some point in the transaction's lifecycle, although it can encompass a wider range of technologies such as e-mail as well. E-commerce sellers (e.g., original equipment manufacturers (OEMs), retailers, resellers, distributors) typically have a need for detailed product information (e.g., specifications, OEM marketing descriptions, product images, product search, product comparison, product configuration, and identification/configuration of product accessories and related products) to support interactions with consumers. In addition to product information, other information, such as promotional information, e.g., rebates, coupons, and sweepstakes, can be included with the product information, or sent in response to a separate query.

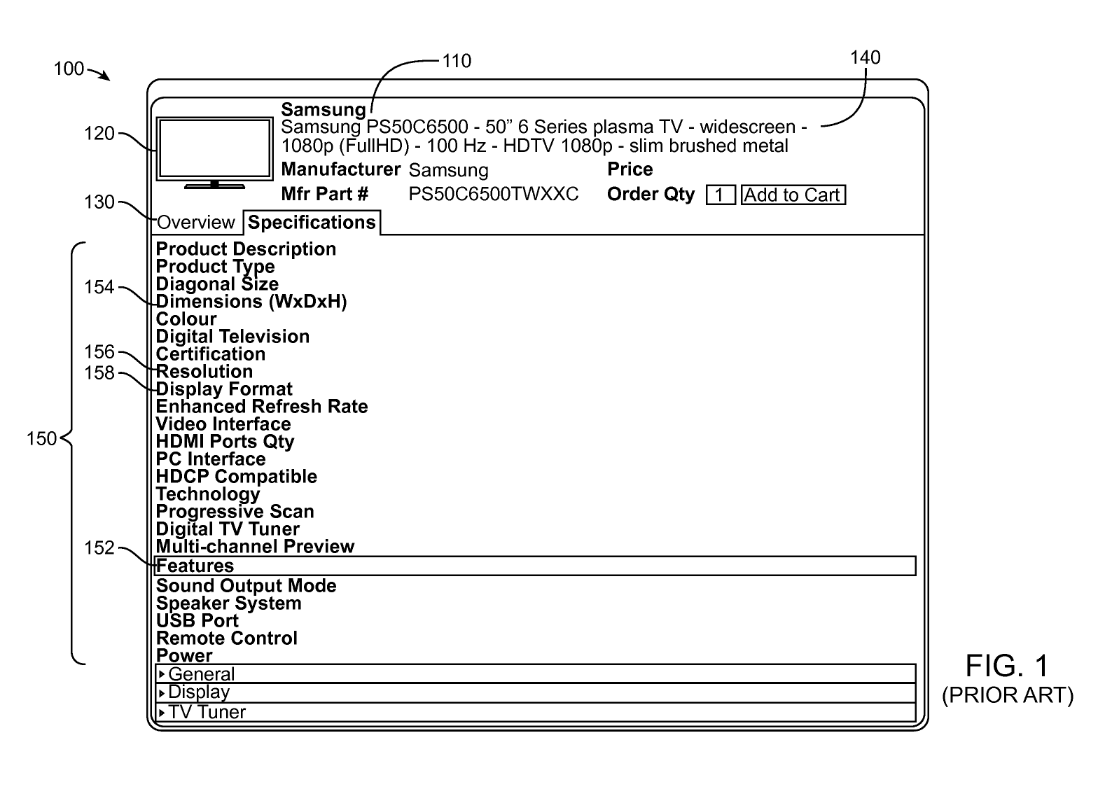

FIG. 1 illustrates how an electronic storefront providing product information can be presented via HTML code using a generic template 100 on a typical webpage. The example format includes: a title 110; a product image 120; a short description 130 of what is included with the product; a marketing description (typically from the product OEM) 140; and a main product specification 150, which includes features 152, dimensions 154, resolution 156, and display format 158, which can be uniformly associated with CE products. Other common product information is illustrated by FIG. 1, but not listed here for brevity.

The product information of FIG. 1 can be retrieved from a local or cloud-based database. In this example, the data is formatted using code integrated in the webpage. Providing custom code to retrieve and format data on a website can be time consuming, error-prone, and costly. Each user of the database provides custom code to retrieve and format the displayed product information, which results in duplication of work and increased costs.

Furthermore, since there is little or no standardization for product information across the broad range of OEMs, retailers, and resellers, obtaining accurate information sufficient to support such consumer interactions can be resource-intensive.

In some embodiments, the technology disclosed herein can be used with services that collect product information from multiple sources, normalize the collected product information in a standard format, store the normalized product information in a structured data repository, such as a product information database, and provide an interface for clients such as e-commerce sellers. In other words, embodiments of the present technology can facilitate a vendor in obtaining normalized product information to support interactions with consumers. The CNET® Content Solutions DataSource™ product information service is an example of such a system. The CNET® Content Solutions DataSource™ provides normalized information on consumer electronics that can be used by online retailers such as Best Buy®. The CNET® Content Solutions DataSource™

A client (e.g., an e-commerce seller) can provide product identification data (e.g., product title, product OEM, product OEM part number) as input to such product information services. As an initial task to providing normalized product information, requests can be mapped to appropriate entries in the stored normalized product information, e.g., the product information database, and indexes thereof.

Embodiments can also include presenting the normalized product information in a widget instead of providing custom code to format the product information. The widget can be generated by the host of the product information, and integrated into any webpage, thereby obviating the need for the e-commerce vendor to format the product information. Therefore, each e-commerce vendor that uses the product information service can simply integrate the widget into their website without the need to generate custom code to retrieve and format product information.

Integration of the widget into a website does not generally require backend server integration. For example, a JavaScript hook can be placed on a webpage. An exemplary JavaScript widget can be a script tag that takes parameters, and returns JavaScript that dynamically adds content to a web page. For example, a website developer can put a snippet of code, such as the following, to generate a widget for his webpage.

<script type=″text/javascript″ language=″javascript″ src=″finder/finder.nocache.js?
account=demo-ja&finderType=tv&hostName=stage-finders.cnetcontentsolutions.com&
protocol=http&port=80&container=ccFinderDiv″></script>

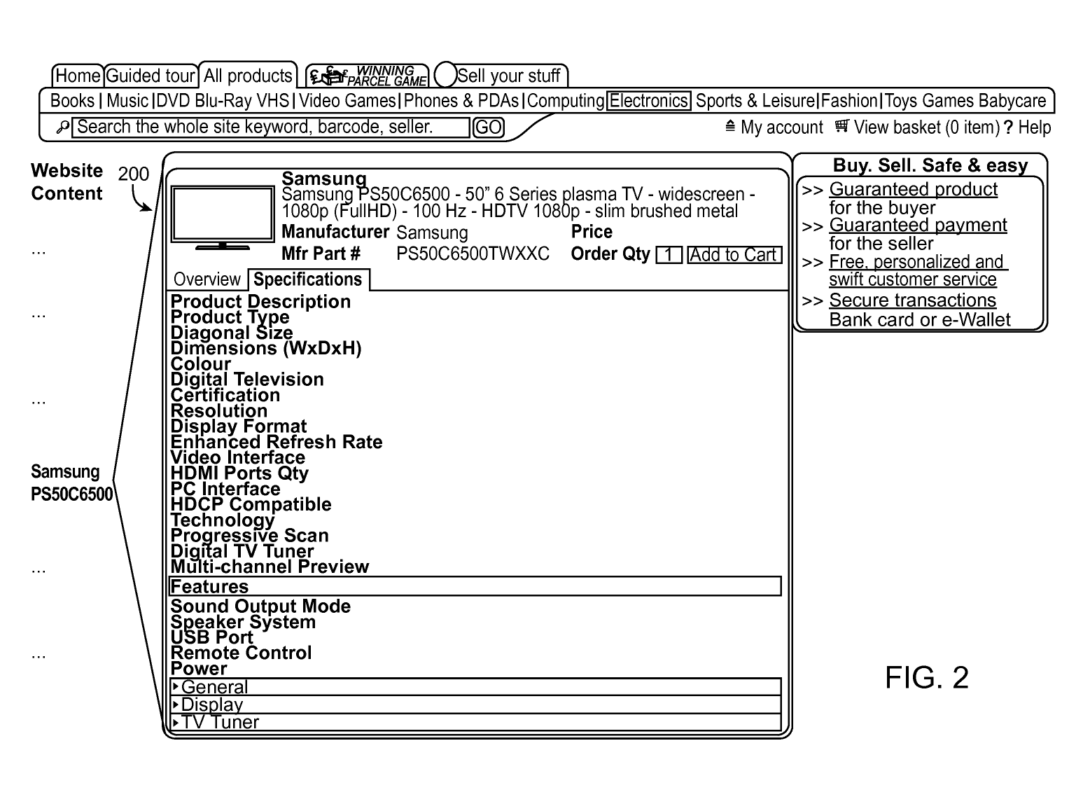

FIG. 2 illustrates the product information of FIG. 1, but the product information can be presented in widget 200 instead of being rendered directly by the source code of the webpage. The information displayed on the webpage can be similar, if not identical, to the information in generic template 100 of FIG. 1; however, using a widget 200 instead provides advantages as enumerated in this disclosure. For example, instead of using generic template 100, a more seamless presentation can be effected by the widget 200.

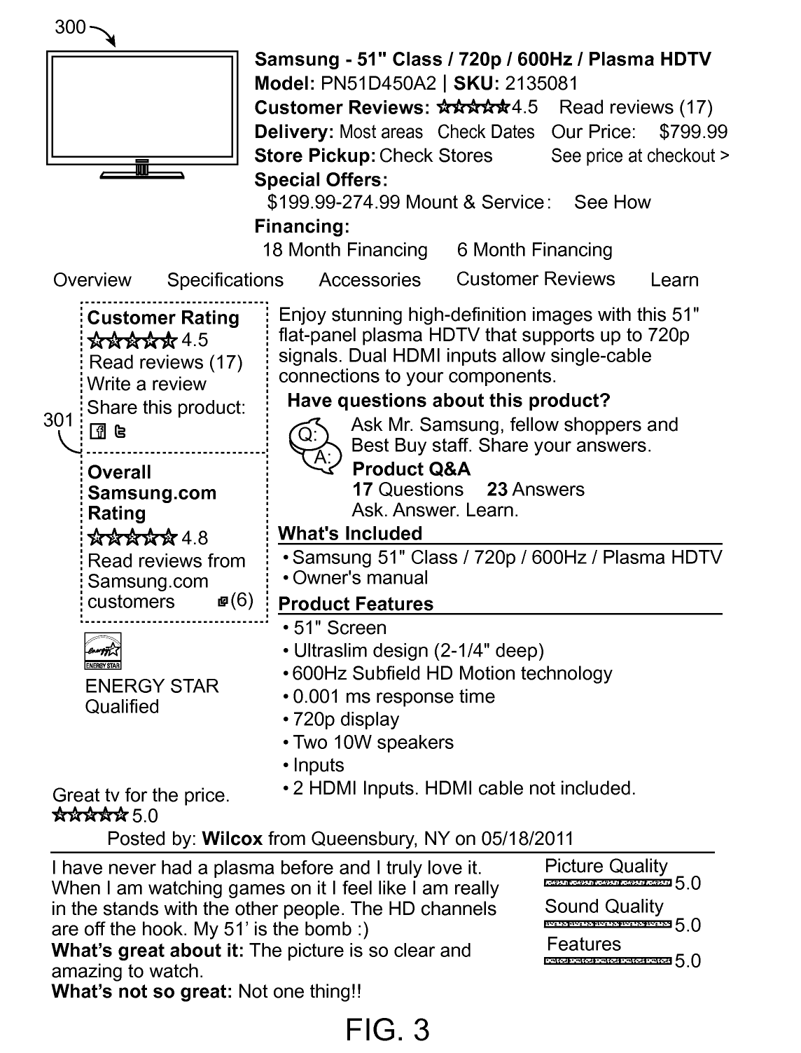

FIG. 3 shows an exemplary embodiment including a product and/or user reviews widget on a website. Webpage 300 comprises widget 301, which can comprise a preconfigured template for displaying information in a customized fashion. The preconfigured template for widget 301 can be configured by the vendor of the product identification data based on instructions from a client (e.g., website owner). In this manner, widget 301 can present information in a seamless fashion such that the product identification information has an integrated look and feel as to not appear generic, which can give webpage 300 a professional appearance. Much of the same information displayed in widget 200 can also be displayed in widget 301, albeit the information can be displayed differently. In some embodiments, the storefront widget 301 can present product information such as product reviews (e.g., by a third party reviewer) and/or user reviews (e.g., by consumers), as illustrated in FIG. 3.

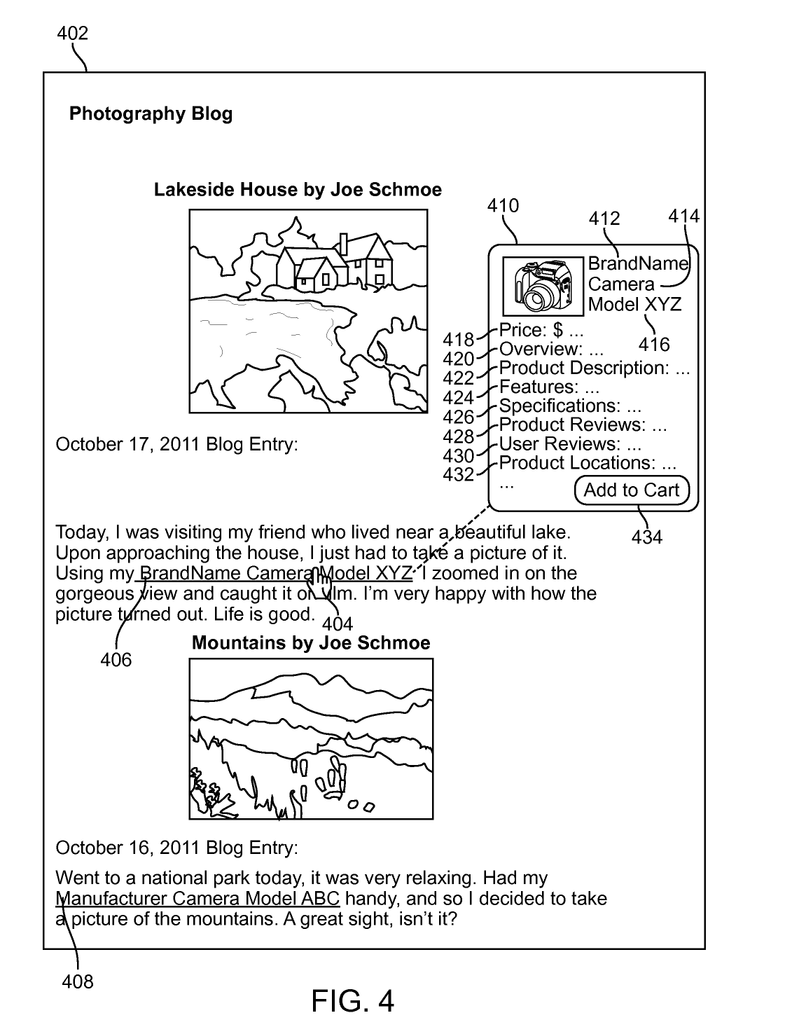

FIG. 4 illustrates an exemplary embodiment including a widget for providing a storefront and displaying product information. In some embodiments, a website developer can be provided a snippet of computer code, such as JavaScript, to generate a widget on the developer's website, as illustrated in FIG. 4. When a user or viewer of the website (e.g., potential consumer) browses the website 402, he can hover or roll his mouse pointer 404 over a product 406. When hovering over a product 406 (e.g., during a mouse rollover), a widget 410 can automatically be displayed to the user. The widget 410 can communicate with a remote database to retrieve and display various information and data about the product, such as the brand name 412 (i.e., manufacturer), the product name/type 414, the model 416, the price 418, an overview 420 of the product, a product description 422, features 424, technical specifications 426, product reviews 428 (e.g., by the website, by a third party, by a server hosting the remote database), user reviews 430, product availability and locations 432, and other information.

Moreover, in some embodiments, the widget can provide a button 434 for purchasing the product (e.g., “Add to Cart,” “Buy Now,” “Purchase,” “Checkout”). As such, the widget 410 can serve as a storefront for the website. Furthermore, in some embodiments, the widget 410 can provide the various information by comprising other widgets, such as a product data widget, a shopping cart widget, and a purchase widget. For example, the information and data relating to the product can be retrieved by the product data widget from a remote database/server, and the shopping cart and purchase widgets can communicate with the same or a different remote server (e.g., customer store service with retailer/prices catalog) to carry out their shopping related tasks.

In some embodiments, a widget 410 can be used with a product finder. The product finder can automatically find products (e.g., 406, 408) on a webpage. An anchor can be created for each of these products. Information about these products can then be retrieved from a remote database by the widget 410 to be displayed on the webpage to a viewer of the webpage. As the viewer hovers his mouse over each product on the webpage, a widget can be displayed to allow him to view information relating to the respective product as well as to purchase the product. Thus, a widget can serve as a storefront for any website, thereby obviating the need for the website to implement its own product database and/or storefront.

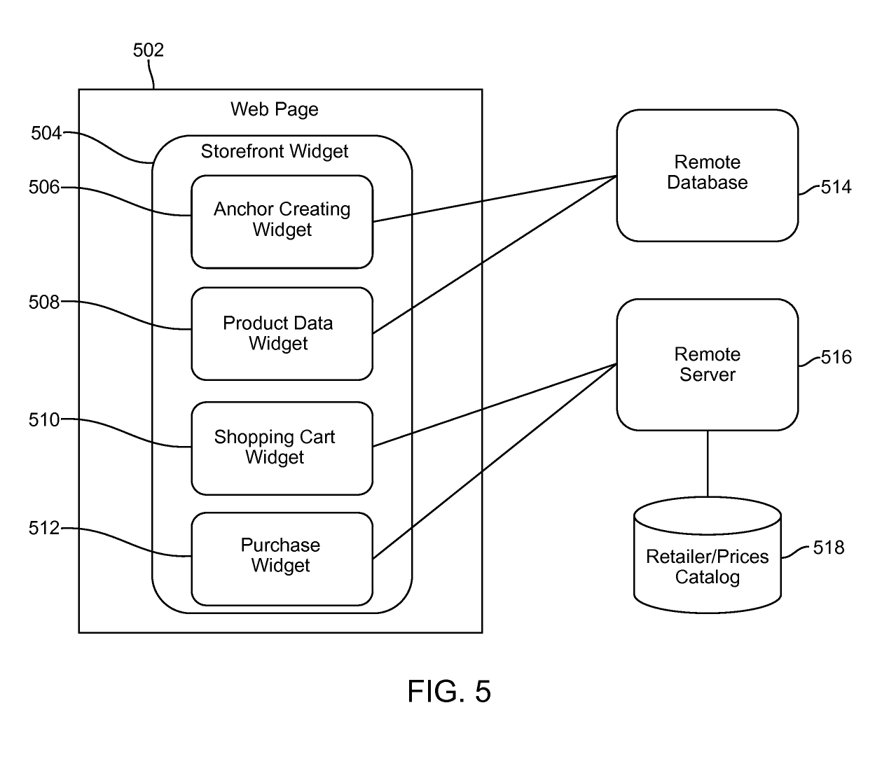

Referring to FIG. 5, an exemplary embodiment including a storefront widget communicating with a remote server(s) is shown. The storefront widget 504 can reside on a webpage 502 and can comprise other widgets (e.g., widgets within a widget). For example, the widget 504 can comprise another widget 506 to create an anchor for each product on the webpage (e.g., an anchor can be created from the website text naming the product). There can also be a widget 508 for accessing product data. These widgets 506 and 508 can communicate with a remote database 514 storing product data to carry out their tasks. Moreover, in some embodiments, there can a shopping cart widget 510 and/or a purchase widget 512 to handle shopping tasks. These widgets 510 and 512 can communicate with a remote server 516, which can, for example, utilize a retail/prices catalog 518 to serve retailer and pricing information. In some embodiments, the remote database 514 and remote server 516 are separate (e.g., two separate servers). In some embodiments, the remote database 514 and the remote server 516 function together (e.g., one server). Similarly, the remote server 516 and the retailer/prices catalog can be a single entity or multiple separate entities.

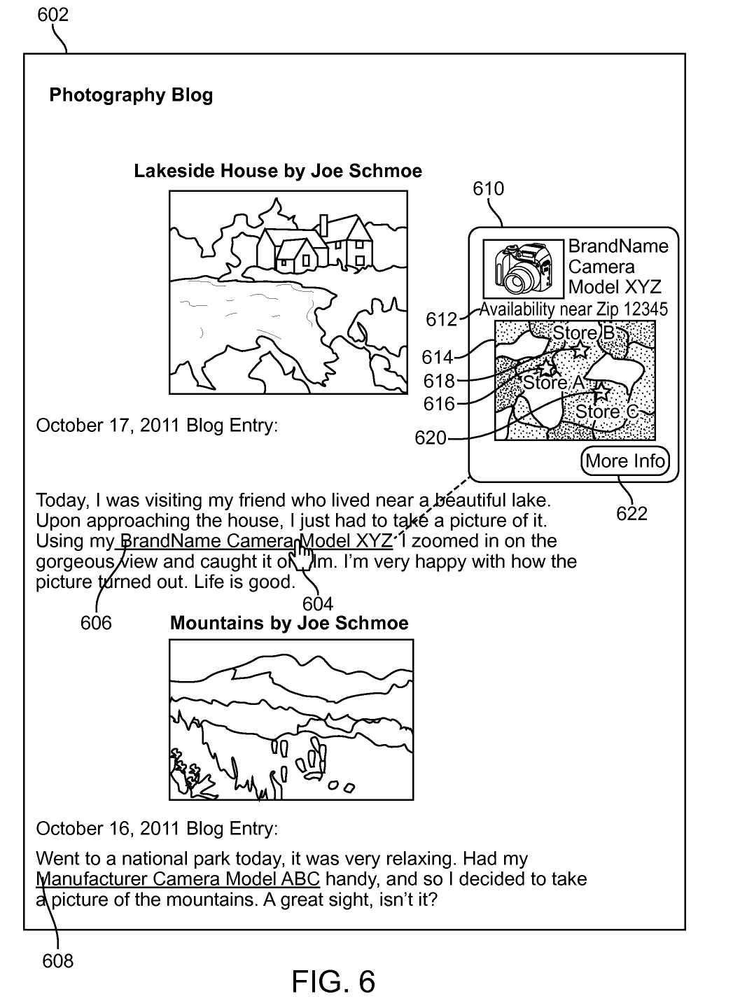

In some embodiments, a widget 610 can be used with a mapping tool or service to provide product location and/or availability, as shown in FIG. 6. If a consumer (e.g., website viewer) wants to purchase the product in person at a physical location, or if he wants to check out the product in person, the widget 610 can retrieve product availability and/or location information from a remote server to display such information to the consumer. For example, the widget 610 can request the consumer to input a zip code and/or address 612. Based on the zip code or address input, the widget can communicate with the remote server and/or a mapping service to retrieve information regarding where the product is available near that zip code or address. The widget can display where the product can be found on a map 614 of the zip code or address. The places where the product should be available can be marked (e.g., stores A, B, and C are marked with stars 616, 618, and 620, respectively). In some embodiments, the widget can provide more information, for example, by clicking a button 622 which can provide information such as store hours, store addresses, directions to get to the store(s), store contact information, etc.

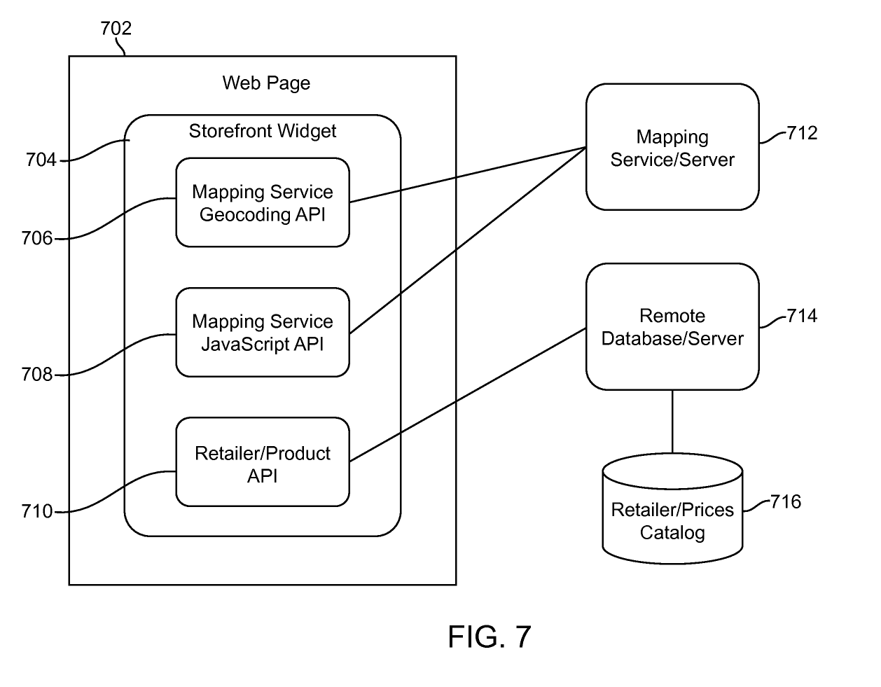

Referring to FIG. 7, an exemplary embodiment including a storefront widget communicating with a mapping service is shown. The storefront widget 704 can reside on a webpage 702 and can comprise various components. For example, the widget 704 can comprise a mapping service geocoding Application Programming Interface (API) 706, which can be useful for finding the street address of a store. The widget can also comprise a mapping service JavaScript API 708, which can be used to embed a map and mapping functions within the storefront widget 704. These APIs 706 and 708 can communicate with the mapping service 712 to carry out their mapping tasks. Moreover, the widget 704 can include a retailer/product API 710, which can be useful for retrieving retailer and/or product information from a remote database/server 714. In some embodiments, the remote server 714 can communicate with a retailer/prices catalog 716 for retailer and/or pricing information. The mapping service 712, remote database 714, and catalog 716 can be hosted on a single entity (e.g., one remote server) or on separate entities (e.g., multiple remote servers).

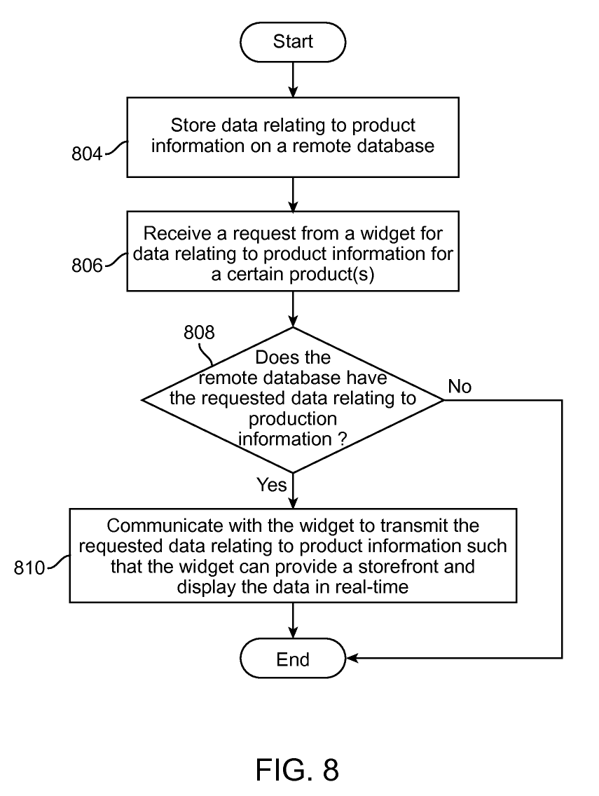

FIG. 8 illustrates an exemplary method embodiment for facilitating a widget to provide a storefront on a website to display product information in real-time. The method embodiment involves storing 804 data relating to product information on a remote database. For example, a remote server can host a database that stores normalized product information, such as consumer electronic product data and manufacturer marketing content, and parametrically searchable product specifications. In some embodiments, a remote server/database can receive 806 a request from a widget on a website for data relating to product information for a certain product(s). The remote server/database can check 808 whether it has the requested data. If not, the method terminates. If so, the remote server/database can communicate 810 with the widget to transmit the requested data relating to product information such that the widget can, in real-time, provide a storefront and display the data.

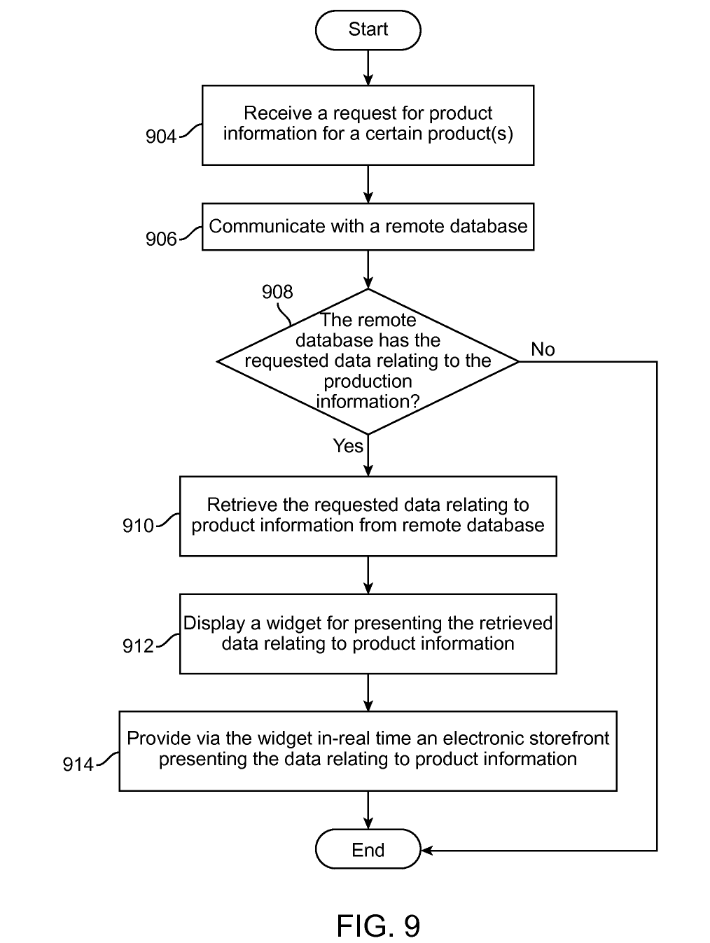

FIG. 9 illustrates an exemplary method embodiment for providing a storefront on a website to display product information in real-time via a widget. The exemplary method embodiment begins with receiving 904 a request for product information for a certain product(s). In some embodiments, a website (or a widget on a website) receives a request for product information for a certain product. For example, a visitor of a webpage desires to access product information for a certain product so he rolls/hovers his mouse over the product name on the webpage. As such, the request to access data relating to product information is received by the webpage (or widget on the webpage). The widget is configured to communicate 906 with a remote database in an attempt to retrieve the requested information. If the remote database has the requested data 908, then the widget can retrieve the data for display 910. The widget and the retrieved data can be displayed in real-time 912. The widget can provide 914 an electronic storefront presenting the retrieved data and, in some embodiments, also a button(s) for convenient shopping (e.g., “Add to Wishlist,” “Buy,” “Checkout”).

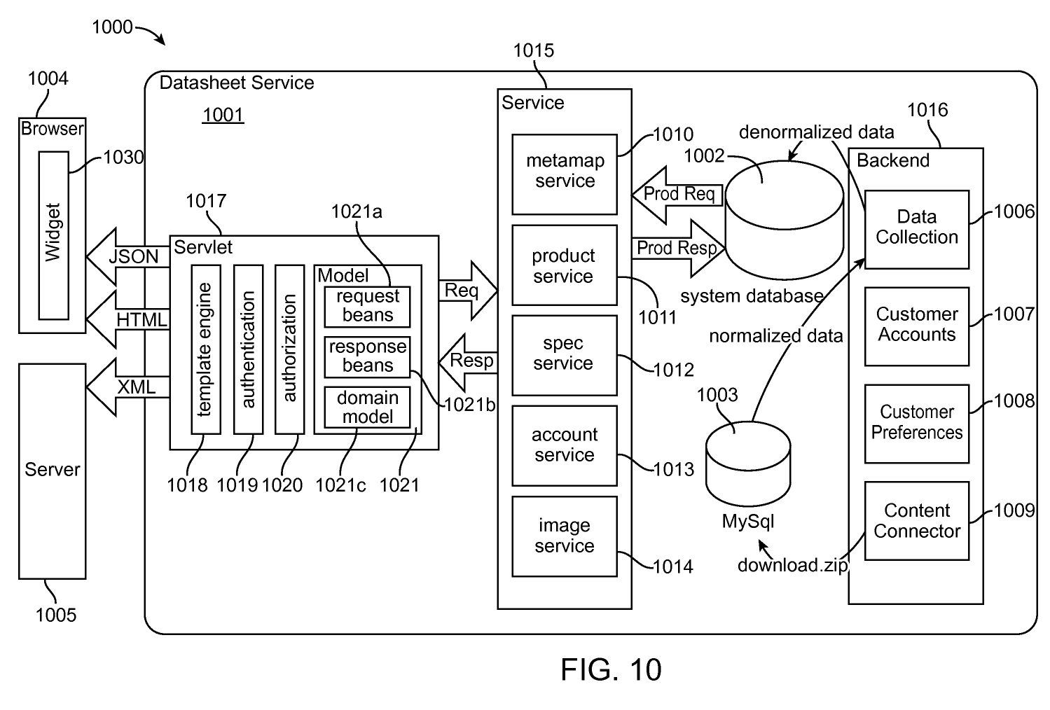

FIG. 10 illustrates an exemplary system embodiment for serving product information to a web server. FIG. 10 shows a server 1005, which can host an e-commerce website. On the backend 1016, there can be a data collection function 1006, customer accounts 1007, customer preferences 1008, and content connector 1009. Content connector 1009 can normalize product information received from vendors, e.g., download.zip, and can export the normalized product information into MySQL database 1003. Data collection function 1006 can be used to denormalize data, e.g., store the information in a custom fashion, from MySQL database 1003, and store the data in to system database 1002. Customer accounts 1007 can store customer information such as addresses, payment histories and subscription levels. Customer preferences 1008 can store information such as which product information to send when a query is received, or how the data should be presented. The customer preferences 1008 can be configured when the customer sets up an account with datasheet service 1001.

Datasheet service 1001 can comprise a plurality of services 1015 for interfacing backend 1016 with servlet 1017. For example, FIG. 10 illustrates metamap service 1010, which can map product identifiers received from server 1005 with product information stored in system database 1002 and MySql database 1003. Product service 1011 can deliver basic product information such as a brief product description. Spec service 1012 can deliver detailed product specifications. Account service 1013 can give an e-commerce website administrator access to their datasheet service account tracked in customer accounts 1007. Image service 1014 can provide an image associated with the product identifier received from either browser 1004 or web server 1005.

Servlet 1017, also illustrated in FIG. 10, can be implemented, for example, in Java to provide a request-response interface with, on one side, browser 1004 and web server 1005, and on the other side, services 1015. Servlet 1017 can comprise a template engine 1018, authentication module 1019, authorization module 1020, and model 1021. Template engine 1018 can format product information into an XML, HTML or JSON templates for insertion into a widget in browser 1004. Authentication module 1019 can authenticate server 1005 to determine whether the server 1005 is bona fide by, for example, using a security certificate or secure token passed along with a request for product information. Authorization module 1020 can determine whether server 1005 has access to particular features of datasheet service 1001 as allowed per a contract between the hosted datasheets provider and the administrator of server 1005. Authorization module 1019 can include access to several services such as the following:
a. A base product service that can include a basic product title and summary.
b. A product images service that can include one or more images of the product.
c. A product spec service that can include detailed product features and specifications.
d. A related products service that can suggest complementary or similar products with slightly different features or prices.
   These different services can be offered in different combinations depending on an e-commerce websites' needs and cost considerations. In addition, the base product service can be broken up into different catalogs, e.g., laptops, cameras, TVs, etc. Breaking out products into catalogs can allow further diversity of prices and allows for more e-commerce websites to tailor their use of the hosted datasheets service 1001 to their particular needs. Finally, servlet 1017 can comprise model 1021, which can include objects in a domain model 1021c, along with Java beans. Java beans are generally reusable software components for Java. In some embodiments, model 1021 can utilize Java beans to provide requests and/or accept responses (e.g., request beans 1021a, response beans 1021b).

Datasheet service 1001 can be customized to particular needs of an e-commerce website. Different levels of service can be established in customer accounts 1007, as discussed above. In addition, preferences can be set in, for example, customer preferences 1008. Preferences include customization, e.g., color and formatting, of the template used by a template engine 1018, number of pages in a template, e.g., an overview, specifications, accessories, product and/or customer reviews, and learn (e.g., glossaries, guides, manuals). Customizations can be established by an e-commerce website when an account is established, which can be done over the Internet or over the phone.

In one example of a transaction between browser 1004, server 1005 and datasheet service 1001, browser 1004 can access a website hosted by server 1005. Browser 1004 can send a query to server 1005 for a product, such as TV. The server 1005 can identify a plurality of TVs matching the query. Each identified TV can have an associated product identifier, or be identified by metadata, which widget 1030 can use to generate queries to datasheet service 1001. The queries can include parameters stating information needed to respond to the query. In one embodiment, only limited information, such as name, picture, and screen size, is needed because a list of TVs will be sent to browser 1004, which has limited area to display information. Moreover, the user of browser 1004 might only want limited information on each product at this time because the user desires to quickly review several TVs to find one for further inspection. However, in some embodiments more or less information can be provided. Queries from widget 1030 can be received by servlet 1017, which can authenticate server 1005, and determine what level of service the server 1005 is authorized to access. The query can be further processed by request beans 1021a to generate a request to services 1015. Services 1015 can then query a database, which in the example of FIG. 10, is system database 1002. Product information in system database 1002 can be formatted according to specifications configured in backend 1016. If the requested data is not yet in system database 1002, it can be retrieved from MySQL database 1003, and denormalized by data collection module 1006, before being stored into system database 1002 and returned to services 1015. Services 1015 can return a response bean to model 1021. Finally, template engine 1018 can format product information received from the response bean into an XML, HTML or JSON widget, which can be sent to server 1005 and forwarded to browser 1004, or the product information can be sent directly to browser 1004 for display in a widget 1030. As such, the widget 1030 can present the product information and provide an electronic storefront in real-time.

Utilizing the embodiments described herein, and exemplified in FIG. 10, e-commerce sellers can have access to a very complete database of product information that would otherwise be cost prohibitive to build and maintain. Benefits of the disclosed embodiments also include maintenance and updating of the product information database, seamless integration into e-commerce websites such that the product information appears to be coming from the e-commerce seller's own website. Also, services can be added or removed as required by specific e-commerce seller's needs, thereby allowing for separate service levels.

Embodiments of the present disclosure also include collecting user reviews and storing them into MySQL database 1003. Social media information about a person's social circle can be gathered from social media networks. The social media information can be used to determine whether friends of the person have reviewed or commented on a product; reviews from friends can be more prominently displayed in customer reviews because they may be more relevant.

Queries can be formed using any database or programming language. The following example illustrates a query using JavaScript.

<script src=″http://hosteddatasheets.com/datasheet?h=CUSTID&view=html&mf
=MANUFACTURER&pn=PROCUCT_ID&locale=LOCALE_CODE&acc=yes″type=″
text/javascript″ defer=″defer″ async=″true″></script>

The query uses the HTML <script> tag, and the ‘src’ parameter defines a query that, in this example, is sent to hosteddatasheets.com. The query above has several parameters (h, view, mf, pn, locale, acc, etc.). Among these parameters, there can be a “type” parameter, which allows a query to identify the type of product information that is requested, e.g., image or datasheet.

In some embodiments, products can be media products such as music, movies, books, TV shows, etc. For example, a widget can be displayed on a webpage where media is mentioned. A webpage can mention a song, movie, TV show, book, etc. (e.g., a blogger on a blog site can talk about his favorite book, a person on a social networking site can mention a movie title, a web user can update his status message to reflect what song he is listening to at the moment). A widget can be displayed for each of these media products as a person browsing these sites (i.e., potential consumer) hovers his mouse over them. The widgets can provide the full product name (e.g., title), author, director, producer, editor, cast, a sample media clip, excerpt, or abstract, price, and other information about the media product. In some embodiments, widgets can provide a click button(s) for convenient shopping (e.g., “Purchase,” “Bid,” “Add to cart,” “Process”).

In some embodiments, a webpage can display a video. There can be a product(s) shown within the video. A widget can be displayed to a visitor of the webpage to provide him with information and data relating to the product(s) in the video. For example, if the video has been tagged with a keyword(s) “Brand name Camera Model XYZ,” then the widget can be made available to the visitor to display product information about the camera (e.g., when the visitor moves his mouse over the product shown in the video, when the visitor moves his mouse over the video tag/keyword). Similarly, if the video properties state which camera was used to record the video, then the widget can also display product information about the camera to the visitor. In addition, if the video description mentions the camera, the widget can display product information about the camera.

In some embodiments, a webpage can present audio. There can be a product(s) mentioned within the audio. A widget can be displayed to a visitor of the webpage to provide him with information and data relating to the product(s) in the audio. For example, if the audio has been tagged with a keyword(s) “Brand name Microphone Model XYZ,” then the widget can be made available to the visitor to display product information about the microphone. Similarly, if the audio properties or description mentions the microphone, then the widget can also display product information about the microphone to the visitor. In addition, in some embodiments, speech-to-text software can be used to decipher the audio into text. If the audio and/or text mention the microphone, the widget can display information about it.

In some embodiments, a webpage can present an image. There can be a product(s) depicted within the image. For example, the picture can have a description or tags describing it. Any products mentioned can be provided by a storefront widget. In some embodiments, a person's face can be deciphered using facial recognition software. The person can be an author, singer, actor, etc. Media and other products associated with the person can be provided by the widget. Similarly, any other products recognized in the image can be provided by the widget as well.

In some embodiments, a webpage can present a game. In the game, there can be any number of real or virtual products. For example, in a Role Playing Game, a real or virtual item can be presented as a product via a widget. In a racing game, a car within the game can be presented as a product via a widget. Moreover, the game can utilize real or virtual currency for shopping. A widget can provide a storefront for using real and/or virtual currency.

In some embodiments, a webpage can present a restaurant or other business. A widget on the webpage can provide meal vouchers, coupons, tickets, or any other merchandise/products mentioned.

In some embodiments, a widget can be a JavaScript hook. In some embodiments, a widget can be generated from computer code including JavaScript, jQuery, HTML, HTML5, or any combination of these and/or other programming languages.

In some embodiments, a widget can disappear when the mouse is no longer hovering over the product (e.g., over the predefined webpage area representing the product) and/or there can be a “Close” button to close the widget.

In some embodiments, a remote database can be hosted on a remote server. In some embodiments, the remote database and remote server are separate. In some embodiments, a web server can be a server on which a website is hosted. In some embodiments, a web server is a server connected to the World Wide Web (e.g., the Internet). In some embodiments, a system database implements an Apache Cassandra database management system.

In some embodiments, a remote server can aggregate data. A remote server can collect data from a website (or a widget on a website). For example, as a webpage visitor hovers his mouse over a product, data in the form of a request is transmitted to a remote server. The fact that a visitor is hovering his mouse over a certain product can be useful data for research, statistics, marketing, sales, and other purposes. In addition, if the visitor decides to purchase a product, the fact that the visitor made the purchase can be useful data as well. For example, the remote server can aggregate data to determine and/or predict which products will likely be of interest to which potential consumers.

In some embodiments, the data aggregation can be “passive” with respect to the website (e.g., or widget on the website, or visitor of the website) in that there need not be any extra processing for the website to perform in order to transmit the data. For example, if webpage visitor is already hovering his mouse over a product or has already clicked to purchase a product (or bid, add to cart, etc.), then the remote server will receive, respectively, a request for product information or a request to process the order. Since the remote server will receive these requests anyway, it can collect data about these requests, whereas the webpage (e.g., or widget, or visitor) need not incur additional processing. As mentioned above, the collected data can be useful for research, statistics, marketing, sales, etc.

The technology can take the form of an entirely hardware embodiment, an entirely software embodiment or an embodiment containing both hardware and software elements and modules. In one embodiment, the technology is implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system.

A data processing system suitable for storing program code and for executing program code will include at least one processor, e.g., processor resources, coupled directly or indirectly to memory elements through a system bus, or chipset. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

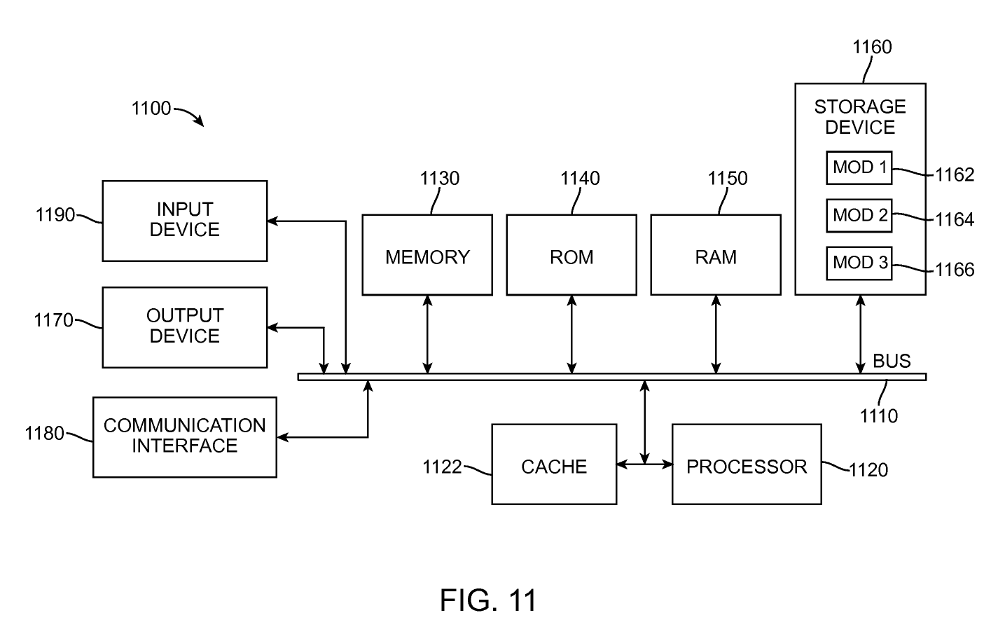

For example, FIG. 11 illustrates an exemplary system 1100, and includes a general-purpose computing device 1100, including a processing unit (CPU or processor) 1120 and a system bus 1110 that couples various system components including the system memory 1130 such as read only memory (ROM) 1140 and random access memory (RAM) 1150 to the processor 1120. The system 1100 can include a cache of high speed memory connected directly with, in close proximity to, or integrated as part of the processor 1120. The system 1100 copies data from the memory 1130 and/or the storage device 1160 to the cache for quick access by the processor 1120. In this way, the cache provides a performance boost that avoids processor 1120 delays while waiting for data. These and other modules can control or be configured to control the processor 1120 to perform various actions. Other system memory 1130 may be available for use as well. The memory 1130 can include multiple different types of memory with different performance characteristics. It can be appreciated that the disclosure may operate on a computing device 1100 with more than one processor 1120 or on a group or cluster of computing devices networked together to provide greater processing capability. The processor 1120 can include any general purpose processor and a hardware module or software module, such as module 1 1162, module 2 1164, and module 3 1166 stored in storage device 1160, configured to control the processor 1120 as well as a special-purpose processor where software instructions are incorporated into the actual processor design. The processor 1120 may essentially be a completely self-contained computing system, containing multiple cores or processors, a bus, memory controller, cache, etc. A multi-core processor may be symmetric or asymmetric.

The system bus 1110 may be any of several types of bus structures including a memory bus or memory controller, a peripheral bus, and a local bus using any of a variety of bus architectures. A basic input/output (BIOS) stored in ROM 1140 or the like, may provide the basic routine that helps to transfer information between elements within the computing device 1100, such as during start-up. The computing device 1100 further includes storage devices 1160 such as a hard disk drive, a magnetic disk drive, an optical disk drive, tape drive or the like. The storage device 1160 can include software modules 1162, 1164, 1166 for controlling the processor 1120. Other hardware or software modules are contemplated. The storage device 1160 is connected to the system bus 1110 by a drive interface. The drives and the associated computer readable storage media provide nonvolatile storage of computer readable instructions, data structures, program modules and other data for the computing device 1100. In one aspect, a hardware module that performs a particular function includes the software component stored in a non-transitory computer-readable medium in connection with the necessary hardware components, such as the processor 1120, bus 1110, display 1170, and so forth, to carry out the function. The basic components are known to those of skill in the art and appropriate variations are contemplated depending on the type of device, such as whether the device 1100 is a small, handheld computing device, a desktop computer, or a computer server.

Although the exemplary embodiment described herein employs the hard disk 1160, it should be appreciated by those skilled in the art that other types of computer readable media which can store data that are accessible by a computer, such as magnetic cassettes, flash memory cards, digital versatile disks, cartridges, random access memories (Rams) 1150, read only memory (ROM) 1140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1100, an input device 1190 represents any number of input mechanisms, such as a microphone for speech, a touch-sensitive screen for gesture or graphical input, keyboard, mouse, motion input, speech and so forth. An output device 1170 can also be one or more of a number of output mechanisms known to those of skill in the art. In some instances, multimodal systems enable a user to provide multiple types of input to communicate with the computing device 1100. The communications interface 1180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1120. The functions these blocks represent may be provided through the use of either shared or dedicated hardware, including, but not limited to, hardware capable of executing software and hardware, such as a processor 1120, that is purpose-built to operate as an equivalent to software executing on a general purpose processor. For example the functions of one or more processors presented in FIG. 11 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1140 for storing software performing the operations discussed below, and random access memory (RAM) 1150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1100 shown in FIG. 11 can practice all or part of the recited methods, can be a part of the recited systems, and/or can operate according to instructions in the recited non-transitory computer-readable storage media. Such logical operations can be implemented as modules configured to control the processor 1120 to perform particular functions according to the programming of the module. For example, FIG. 11 illustrates three modules Mod1 1162, Mod2 1164 and Mod3 1166 which are modules configured to control the processor 1120. These modules may be stored on the storage device 1160 and loaded into RAM 1150 or memory 1130 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be used to host many different types of information other than consumer electronics product information, e.g., information regarding sporting goods, cars, medicine, etc. Those skilled in the art will readily recognize various modifications and changes that may be made to the principles described herein without following the example embodiments and applications illustrated and described herein, and without departing from the spirit and scope of the disclosure.

We claim:

1. A computer-implemented method for providing an external online storefront to a website that otherwise lacks a storefront, the method comprising:
providing a widget on a webpage defined by computer-readable code, the webpage referencing a product;
identifying, by the widget, data identifying the product;
sending the data identifying the product to an external product reference resource;
receiving product data from the external product reference resource; and
providing an online storefront by the widget by presenting the received product data.

2. The computer-implemented method of claim 1, wherein the data identifying the product comprises text relating to the product.

3. The computer-implemented method of claim 1, wherein the data identifying the product comprises a visualization relating to the product.

4. The computer-implemented method of claim 1, wherein the data identifying the product comprises audio relating to the product.

5. The computer-implemented method of claim 1, wherein the product data comprises data relating to a product specification.

6. The computer-implemented method of claim 1, wherein the product data comprises data relating to purchase information.

7. The computer-implemented method of claim 1, wherein the product data comprises data relating to a product review.

8. The computer-implemented method of claim 7, wherein the product review comprises a consumer review.

9. The computer-implemented method of claim 1, wherein the product data comprises data relating to a product location.

10. The computer-implemented method of claim 1, wherein the external product reference resource includes normalized product information.

11. The computer-implemented method of claim 1, wherein the external product reference resource brokers a sale of the product.

12. A computer-implemented method comprising:
storing data relating to product information for a collection of products in a remote database;
providing computer code for generating a widget on a website, wherein the computer code is implemented on the domain of the website;
receiving a request from the widget to transmit the data relating to product information for a specified product stored on the remote database; and
aggregating data describing characteristics of the request for the specified product.

13. The computer-implemented method of claim 12, wherein the aggregated data includes an aggregate of the number of requests for the specified product.

14. The computer-implemented method of claim 12, wherein the aggregated data includes a product review.

15. The computer-implemented method of claim 14, wherein the product review comprises a consumer review.

16. The computer-implemented method of claim 12, wherein the aggregated data includes purchase information.

17. The computer-implemented method of claim 16, wherein the purchase information includes information relating to whether the product was purchased.

18. The computer-implemented method of claim 12, further comprising:
analyzing the aggregated data to form a conclusion.

19. The computer-implemented method of claim 18, wherein the formed conclusion includes information relating to product interest metrics.

20. A web server comprising:
a processor;
a remote database configured to store data relating to product information for a collection of products;
a receiver configured to receive a request from a widget to transmit the data relating to product information for a specified product stored on the remote database;
wherein the processor is configured to aggregate data describing characteristics of the request for the specified product; and
wherein the widget is generated on a website using computer code, the computer code being implemented on the domain of the website.

21. The web server of claim 20, wherein the data relating to product information comprises data relating to a product review.

22. The web server of claim 21, wherein the product review comprises a consumer review.

23. The web server of claim 20, wherein the data relating to product information comprises data relating to a product location.

24. A web server for providing an external online storefront to a website that otherwise lacks a storefront, the web server comprising:
a processor configured to provide a widget on a webpage defined by computer-readable code, the webpage referencing a product, and the processor being configured to identify, by the widget, data identifying the product;
a transmitter configured to send the data identifying the product to an external product reference resource;
a receiver configured to receive product data from the external product reference resource; and
wherein the processor is configured to provide an online storefront by the widget by presenting the received product data.

25. The web server of claim 24, wherein the data relating to product information comprises data relating to a product review.

26. The web server of claim 24, wherein the product review comprises a consumer review.

27. The web server of claim 24, wherein the data relating to product information comprises data relating to a product location.

28. A system comprising:
a first web server comprising:
a processor;
a remote database configured to store data relating to product information for a collection of products;
a receiver configured to receive a request from a widget to transmit the data relating to product information for a specified product stored on the remote database;
wherein the processor is configured to aggregate data describing characteristics of the request for the specified product; and
wherein the widget is generated on a website using computer code, the computer code being implemented on the domain of the website; and
a second web server for providing an external online storefront to the website that otherwise lacks a storefront, the second web server comprising:
a processor configured to provide the widget on the website defined by computer-readable code, the website referencing a product, and the processor being configured to identify, by the widget, data identifying the product;
a transmitter configured to send the data identifying the product to an external product reference resource;
a receiver configured to receive product data from the external product reference resource; and
wherein the processor is configured to provide an online storefront by the widget by presenting the received product data.

29. The system of claim 28, wherein the remote database resides with the external product reference resource.

30. A non-transitory computer-readable storage medium having computer-readable instructions stored thereon effective for causing a computer to perform a method comprising:
storing data relating to product information for a collection of products in a remote database;
providing computer code for generating a widget on a website, wherein the computer code is implemented on the domain of the website;
receiving a request from the widget to transmit the data relating to product information for a specified product stored on the remote database; and
aggregating data describing characteristics of the request for the specified product.

31. A non-transitory computer-readable storage medium having computer-readable instructions stored thereon effective for causing a computer to perform a method for providing an external online storefront to a website that otherwise lacks a storefront, the method comprising:
providing a widget on a webpage defined by computer-readable code, the webpage referencing a product;
identifying, by the widget, data identifying the product;
sending the data identifying the product to an external product reference resource;
receiving product data from the external product reference resource; and
providing an online storefront by the widget by presenting the received product data.
